(19) United States
(12) Patent Application Publication
(10) Pub. No.: US 2026/0358164 A1
(43) Pub. Date: Nov. 12, 2026

(54) DETECTION DEVICE FOR DETECTING CAPACITY OF GRANULAR FURNACE MATERIAL BOX

(71) Applicant: ShenZhen Joehy Electronics Co.,Ltd., Shenzhen (CN)

(72) Inventor: Weibing CHEN, Shenzhen (CN)

(21) Appl. No.: 19/533,539

(22) Filed: Feb. 9, 2026

(30) Foreign Application Priority Data
May 7, 2025 (CN) 202520885158.5

(51) Int. Cl. G01F 23/292

(52) U.S. Cl. CPC G01F 23/2928

(57) ABSTRACT

Provided is a detection device for detecting the capacity of a granular furnace material box, including: a main control MCU, the main control MCU is signally connected with a laser emitter and a laser receiver, both of which are provided in the granular furnace material box. The laser transmitter is configured to emit a laser beam, the laser receiver is configured to receive the laser beam reflected by a fuel, and the main control MCU is configured to calculate a fuel capacity in the granular furnace material box based on the laser beam received by the laser receiver. By using laser ranging, the fuel capacity of the material box is calculated, achieving non-contact detection without causing interference or damage to a to-be-tested object, suitable for industrial environments that require precise detection.

### CROSS-REFERENCE TO RELATED APPLICATIONS

This application claims priority to Chinese Patent Application No. 202520885158.5, filed on May 7, 2025, which is hereby incorporated by reference in its entirety.

### TECHNICAL FIELD

The present disclosure relates to the field of material inspection technologies, and in particular, to a detection device for detecting capacity of a granular furnace material box.

### BACKGROUND

The granular furnace material box is a component of the granular furnace, mainly responsible for storing granular fuel and transporting the fuel into the furnace through a discharge pipeline.

In the existing technology, the granular furnace material box lacks a capacity detection device, or the detection device can only detect whether there is a shortage of material, but cannot detect the remaining amount of granular fuel. The users do not know when the particles will be used up or the remaining amount, which affects the user experience.

### SUMMARY

The purpose of the present disclosure is to provide a detection device for detecting capacity of a granular furnace material box, which solves the technical problem of the lack of capacity detection device in the granular furnace material box in the prior art.

To achieve this goal, the present disclosure adopts the following technical solution.

A detection device for detecting capacity of a granular furnace material box, including: a main control MCU, the main control MCU is signally connected to a laser transmitter and a laser receiver, both the laser transmitter and the laser receiver are provided in the granular furnace material box;
the laser emitter is configured to emit a laser beam, the laser receiver is configured to receive the laser beam reflected by a fuel, and the main control MCU is configured to calculate a fuel capacity in the granular furnace material box based on the laser beam received by the laser receiver.

In some embodiments of the present disclosure, the detection device further includes a power supply circuit, a DC-DC conversion circuit, and a photoelectric detection circuit that are sequentially electrically connected;
an input voltage of the power supply circuit is 3V, and an output voltage of the DC-DC conversion circuit is 3.3V.

In some embodiments of the present disclosure, the photoelectric detection circuit includes a signally connected chip U1 and a laser sensor CN4, a 1^{st} pin of the chip U1 is grounded, a 4^{th} pin of the chip U1 is connected to the DC-DC conversion circuit, and 5^{th} and 12^{th} pins of the chip U1 are respectively connected to the power supply circuit;
a 13^{th} pin of the chip U1 is connected in parallel with a capacitor C10, a capacitor C11, and a capacitor C12; both the 13^{th} pin and a 18^{th} pin of the chip U1 are grounded, and the capacitor C10, capacitor C11, and capacitor C12 are grounded.

In some embodiments of the present disclosure, a capacitor C8 and a capacitor C9 are connected between a 1^{st} pin and a 2^{nd} pin of the laser sensor CN4, the capacitor C8 and the capacitor C9 are connected in parallel, the 1^{st} pin of the laser sensor CN4 is connected to +3.3V, and the 2^{nd} pin of the laser sensor CN4 is grounded;
a 3^{rd} pin of the laser sensor CN4 is connected to a resistor R7 and a resistor R10, the resistor R7 is connected to a 10^{th} pin of the chip U1, the resistor R10 is connected to a resistor R9, the resistor R9 is connected to a 16^{th} pin of the chip U1, a resistor R8 is connected to a 17^{th} pin of the chip U1, and the resistor R8 is connected to the power supply circuit.

In some embodiments of the present disclosure, the DC-DC conversion circuit includes a chip U2, a 1^{st} pin of the chip U2 is connected to one end of a resistor R4, the other end of the resistor R4 is connected to the 4^{th} pin of the chip U1, a 2^{nd} pin of the chip U2 is respectively connected to +3.3V, a diode D1, one end of a capacitor C6, and one end of a capacitor C7; and the other ends of the capacitor C6 and capacitor C7 are grounded;
a 4^{th} pin of the chip U2 is connected to a capacitor C4, a capacitor C5, and a 2^{nd} pin of a connector CN2; the 4^{th} pin of the chip U2 is grounded, a 5^{th} pin of the chip U2 is connected to one end of an inductor L1, and the other end of the inductor L1 is connected to the capacitor C4, the capacitor C5, and a 1^{st} pin of the connector CN2.

In some embodiments of the present disclosure, the detection device for detecting capacity of a granular furnace material box further includes a burning circuit, where the burning circuit includes a connector CN3, a 7^{th} pin of the chip U1 is connected to a 3^{rd} pin of the connector CN3, a 1^{st} pin of the connector CN3 is connected to +3.3V, and a 2^{nd} pin of the connector CN3 is grounded.

Compared with existing technologies, the present disclosure has the following beneficial effects.

The present disclosure provides a detection device for detecting capacity of a granular furnace material box, including: a main control MCU, the main control MCU is signally connected with a laser emitter and a laser receiver, both of which are provided in the granular furnace material box. The laser transmitter is configured to emit a laser beam, the laser receiver is configured to receive the laser beam reflected by the fuel, and the main control MCU is configured to calculate the fuel capacity in the granular furnace material box based on the laser beam received by the laser receiver. By using laser ranging, the fuel capacity of the material box is calculated, thereby achieving non-contact detection without causing interference or damage to a to-be-tested object, suitable for industrial environments that require precise detection. Therefore, the present disclosure solves the technical problem of the lack of capacity detection device in the granular furnace material box in the prior art.

### BRIEF DESCRIPTION OF DRAWINGS

In order to provide a clearer explanation of the embodiments of the present disclosure or the technical solutions in the prior art, a brief introduction will be given to the accompanying drawings required for the description of the embodiments or the prior art. It is obvious that the accompanying drawings described below are only some embodiments of the present disclosure. For those skilled in the art, other drawings can be obtained based on these drawings without creative work.

The structure, proportion, size, etc. shown in the accompanying drawings of this specification are only for the purpose of cooperating with the content disclosed in the specification, for the understanding and reading of those familiar with this technology, and are not intended to limit the conditions under which the present disclosure can be implemented. Therefore, they do not have substantive technical significance. Any modification of the structure, change in the proportion relationship, or adjustment of the size should still fall within the scope of the technical content disclosed in the present disclosure without affecting the efficacy and purpose that can be achieved by the present disclosure.

FIG. 1 is a schematic structural diagram of a detection device for detecting capacity of a granular furnace material box provided by the present disclosure.

FIG. 2 is a schematic diagram of a working principle of the detection device for detecting capacity of a granular furnace material box provided by the present disclosure.

FIG. 3 is a circuit schematic diagram of a power supply circuit in the detection device for detecting capacity of a granular furnace material box provided by the present disclosure.

FIG. 4 is a circuit schematic of a Direct Current to Direct Current Converter, (DC-DC) conversion circuit in the detection device for detecting capacity of a granular furnace material box provided by the present disclosure.

FIG. 5 is a circuit schematic of a photoelectric detection circuit in the detection device for detecting capacity of a granular furnace material box provided by the present disclosure.

FIG. 6 shows a circuit principle of a photoelectric burning circuit in the detection device for detecting capacity of a granular furnace material box provided by the present disclosure.

### DESCRIPTION OF EMBODIMENTS

In order to make the purpose, features, and advantages of the present disclosure more obvious and understandable, the technical solutions in the embodiments of the present disclosure will be clearly and completely described in combination with the accompanying drawings. Obviously, the embodiments described below are only a part of the embodiments of the present disclosure, not all of them. Based on the embodiments in the present disclosure, all other embodiments obtained by those skilled in this field without creative work are within the protection scope of the present disclosure.

In the description of the present disclosure, it should be understood that terms “up”, “down”, “top”, “bottom”, “inside”, “outside”, etc. indicate orientation or positional relationships based on the orientation or positional relationships shown in the accompanying drawings, only for the convenience of describing the present disclosure and simplifying the description, and do not indicate or imply that the device or component referred to must have a specific orientation, be constructed and operated in a specific orientation, and therefore cannot be understood as limiting the present disclosure. It should be noted that when a component is considered to be “connected” to another component, it can be directly connected to another component or there may be a centrally located component at the same time.

The technical solution of the present disclosure will be further explained through specific implementation modes in combination with the accompanying drawings.

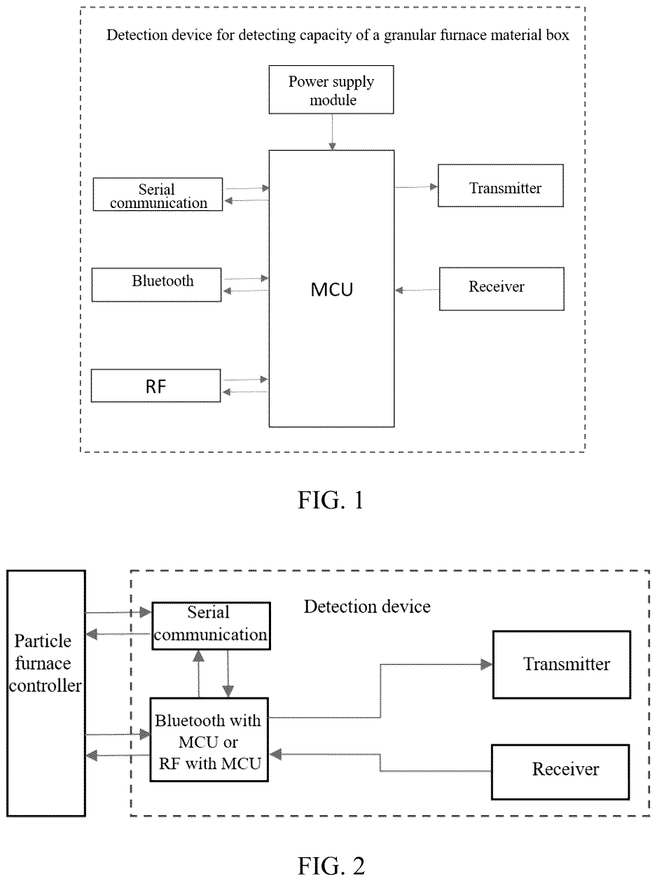

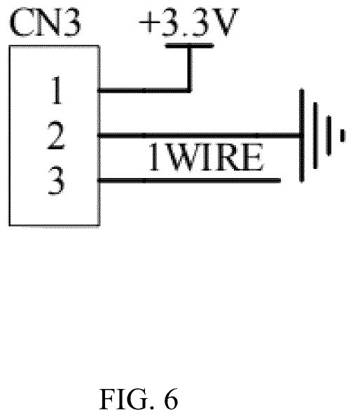

An embodiment of the present disclosure provides a detection device for detecting capacity of a granular furnace material box, as shown in FIGS. 1 to 6, including: a main control Microcontroller Unit, (MCU), the main control MCU signal is connected to a laser transmitter and a laser receiver, both the laser transmitter and the laser receiver are provided in the granular furnace material box.

The laser transmitter is configured to emit a laser beam, the laser receiver is configured to receive the laser beam reflected by a fuel, and the main control MCU is configured to calculate a fuel capacity in the granular furnace material box based on the laser beam received by the laser receiver.

It should be noted that the present disclosure provides a detection device for detecting capacity of a granular furnace material box, including a main control MCU, the main control MCU signal is connected with a laser transmitter and a laser receiver, both of which are provided in the granular furnace material box. The laser transmitter is configured to emit a laser beam, the laser receiver is configured to receive the laser beam reflected by the fuel, and the main control MCU is configured to calculate the fuel capacity in the granular furnace material box based on the laser beam received by the laser receiver. By using laser ranging, the fuel capacity of the material box is calculated, thereby achieving non-contact detection without causing interference or damage to the to-be-tested object, suitable for industrial environments that require precise detection. Therefore, the present disclosure solves the technical problem of the lack of capacity detection device in the granular furnace material box in the prior art.

As shown in FIGS. 1 to 6, the detection device further includes a power supply circuit, a DC-DC conversion circuit, and a photoelectric detection circuit that are sequentially electrically connected. In this embodiment, the photoelectric detection circuit calculates the fuel capacity by determining a return time or an intensity of the laser beam, etc. ; This conversion method is a well-known technique in this field and will not be repeated here.

An input voltage of the power supply circuit is 3V, and an output voltage of the DC-DC conversion circuit is 3.3V.

It should be noted that the input 3V voltage is converted into a 3.3V output voltage to meet voltage requirements of different circuits or devices. The entire system is provided with a stable 3V power supply by the power supply circuit, and the DC-DC conversion circuit boosts it to 3.3V to ensure that all components work properly.

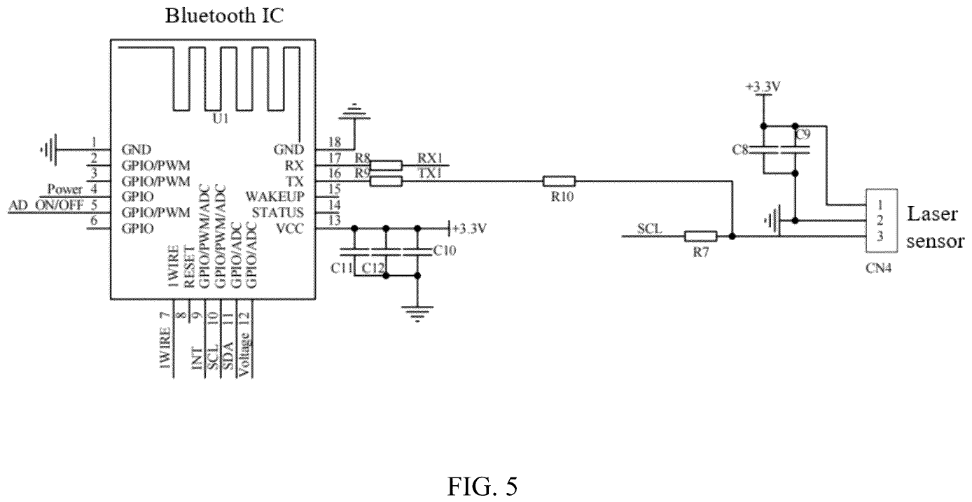

As shown in FIG. 5, the photoelectric detection circuit includes a signally connected chip U1 and a laser sensor CN4. A 1^{st} pin of the chip U1 is grounded, a 4^{th} pin of the chip U1 is connected to the DC-DC conversion circuit, and a 5^{th} pin and a 12^{th} pin of the chip U1 are respectively connected to the power supply circuit.

A 13^{th} pin of the chip U1 is connected in parallel with a capacitor C10, a capacitor C11, and a capacitor C12. Both the 13^{th} pin and a 18^{th} pin of the chip U1 are grounded, and the capacitor C10, the capacitor C11, and the capacitor C12 are grounded.

It should be noted that by setting capacitors C10, C11, and C12 in parallel, high-frequency noise in the power supply can be filtered out, signal stability can be enhanced, and the chip can operate stably under different working conditions. The parallel configuration increases the total capacity of the capacitors, thereby improving the filtering effect and enhancing the signal-to-noise ratio. By connecting the laser sensor CN4 to the chip U1, the signal returned from the laser emitter (including laser reflection data) can be transmitted to the chip for processing.

As shown in FIGS. 1 to 5, there are a capacitor C8 and a capacitor C9 connected between a 1^{st} pin and a 2^{nd} pin of the laser sensor CN4, and the capacitor C8 and capacitor C9 are connected in parallel. The 1^{st} pin of the laser sensor CN4 is connected to +3.3V, and the 2^{nd} pin of the laser sensor CN4 is grounded.

A 3^{rd} pin of the laser sensor CN4 is connected to a resistor R7 and a resistor R10. A 10^{th} pin of the chip U1 is connected to the resistor R7, a resistor R9 is connected to the resistor R10, and the resistor R9 is connected to a 16^{th} pin of the chip U1. A 17^{th} pin of the chip U1 is connected to a resistor R8, and the resistor R8 is connected to the power supply circuit.

It should be noted that the chip U1 is a photoelectric signal conditioning chip that works in combination with the laser sensor CN4 to achieve signal filtering and impedance matching through a network of resistors (R7-R10) and capacitors (C8-C12). Due to the connection of resistor R7 from 3^{rd} pin of the laser sensor CN4 to 10^{th} pin of the chip U1, it protects the chip and signal source, while also helping to adjust the level of the transmitted signal.

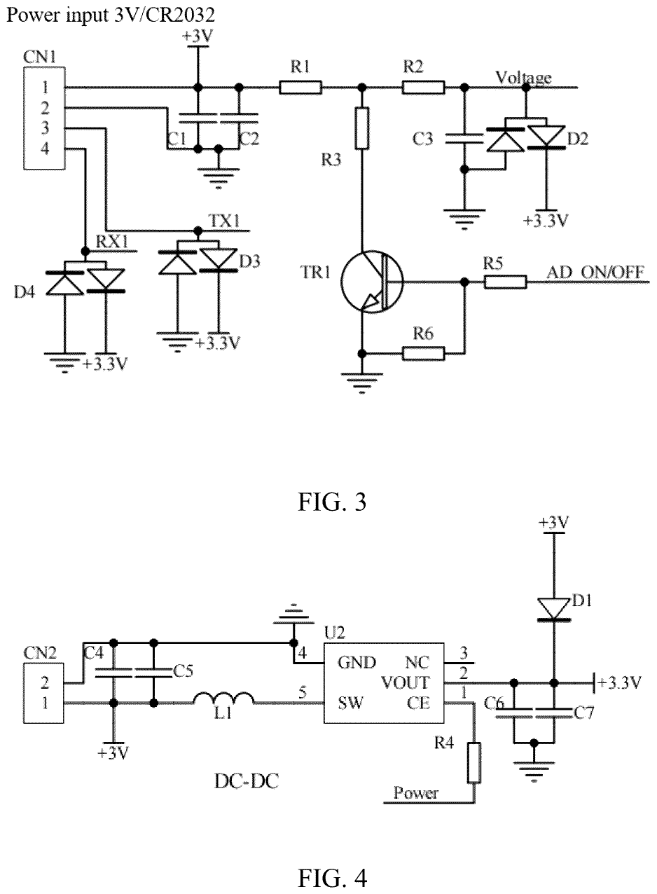

As shown in FIGS. 3 to 5, the DC-DC conversion circuit includes a chip U2. A 1^{st} pin of the chip U2 is connected to one end of a resistor R4, and the other end of the resistor R4 is connected to the 4^{th} pin of the chip U1. A 2^{nd} pin of the chip U2 is respectively connected to +3.3V, a diode D1, one end of a capacitor C6, and one end of a capacitor C7. The other ends of capacitor C6 and capacitor C7 are both grounded.

A 4^{th} pin of the chip U2 is connected to a capacitor C4, a capacitor C5, and a 2^{nd} pin of the connector CN2. The 4^{th} pin of the chip U2 is grounded, a 5^{th} pin of the chip U2 is connected to one end of an inductor L1, and the other end of the inductor L1 is connected to the capacitor C4, the capacitor C5, and a 1^{st} pin of the connector CN2.

It should be noted that due to one end of the resistor R4 being connected to the 1^{st} pin of the chip U2 and the other end being connected to 4^{th} pin of the chip U1, the resistor R4 plays a role in limiting current or determining gain in U2's input or feedback loop, thereby affecting the stability of the output voltage. The diode DI is configured to protect the circuit, prevent reverse current from damaging the chip, or improve the conversion efficiency of the power supply. The capacitors C6 and C7 are configured to smooth the input voltage, reduce power supply noise, and help maintain voltage regulation performance. Due to the other ends of capacitors C6 and C7 being grounded, a decoupling circuit is formed to improve system stability. The capacitors C4 and C5, as output capacitors, help smooth the voltage fluctuations of the DC-DC converter output, reduce noise, and ensure stable power supply to subsequent circuits (such as chip U1). An inductance coil L1 in DC-DC conversion circuits is configured to store energy and help achieve voltage boost or stability.

As shown in FIGS. 3 to 6, the detection device for detecting capacity of a granular furnace material box further includes a burning circuit, and the burning circuit includes a connector CN3. A 7^{th} pin of the chip U1 is connected to a 3^{rd} pin of the connector CN3, a 1^{st} pin of the connector CN3 is connected to +3.3V, and a 2^{nd} pin of the connector CN3 is grounded.

It should be noted that the connector CN3 serves as a main interface for the burning circuit, and is configured to connect external programming devices or programmers for programming operations of the chip U1. By providing the standard connector CN3, the programming of the chip U1 becomes fast and convenient. By connecting to a +3.3V power supply, ensure the normal operation of the chip during programming and provide stable power supply. The grounding design makes communication with external devices more stable and reduces programming errors caused by power fluctuations or interference.

Working principle: the present disclosure provides a detection device for detecting capacity of a granular furnace material box, including: a main control MCU, the main control MCU is signally connected with a laser emitter and a laser receiver, both of which are provided in the granular furnace material box. The laser transmitter is configured to emit a laser beam, the laser receiver is configured to receive the laser beam reflected by the fuel, and the main control MCU is configured to calculate the fuel capacity in the granular furnace material box based on the laser beam received by the laser receiver. By using laser ranging, the fuel capacity of the material box is calculated, thereby achieving non-contact detection without causing interference or damage to a to-be-tested object, suitable for industrial environments that require precise detection. Therefore, the present disclosure solves the technical problem of the lack of capacity detection device in the granular furnace material box in the prior art.

The above embodiments are only configured to illustrate the technical solution of the present disclosure, and not to limit it. Although the present disclosure has been described in detail with reference to the aforementioned embodiments, those skilled in the art should understand that they can still modify the technical solutions described in the aforementioned embodiments, or equivalently replace some of the technical features; and these modifications or substitutions do not depart from the essence and scope of the corresponding technical solutions of the embodiments of the present disclosure.

1. A detection device for detecting capacity of a granular furnace material box, comprising: a main control MCU, the main control MCU is signally connected to a laser transmitter and a laser receiver, both the laser transmitter and the laser receiver are provided in the granular furnace material box;
the laser emitter is configured to emit a laser beam, the laser receiver is configured to receive the laser beam reflected by a fuel, and the main control MCU is configured to calculate a fuel capacity in the granular furnace material box based on the laser beam received by the laser receiver;
wherein the detection device further comprises a power supply circuit, a DC-DC conversion circuit, and a photoelectric detection circuit that are sequentially electrically connected;
wherein the photoelectric detection circuit comprises a signally connected chip U1 and a laser sensor CN4, a 1st pin of the chip U1 is grounded, a 4th pin of the chip U1 is connected to the DC-DC conversion circuit; 5th and 12th pins of the chip U1 are respectively connected to the power supply circuit;
a 13th pin of the chip U1 is connected in parallel with a capacitor C10, a capacitor C11, and a capacitor C12; both the 13th pin and a 18th pin of the chip U1 are grounded, and the capacitor C10, capacitor C11, and capacitor C12 are grounded.

2. The detection device for detecting capacity of a granular furnace material box according to claim 1, wherein
an input voltage of the power supply circuit is 3V, and an output voltage of the DC-DC conversion circuit is 3.3V.

3. (canceled)

4. The detection device for detecting capacity of a granular furnace material box according to claim 1, wherein a capacitor C8 and a capacitor C9 are connected between a 1st pin and a 2nd pin of the laser sensor CN4, the capacitor C8 and the capacitor C9 are connected in parallel, the 1st pin of the laser sensor CN4 is connected to +3.3V, and the 2nd pin of the laser sensor CN4 is grounded;
a 3rd pin of the laser sensor CN4 is connected to a resistor R7 and a resistor R10, the resistor R7 is connected to a 10th pin of the chip U1, the resistor R10 is connected to a resistor R9, the resistor R9 is connected to a 16th pin of the chip U1, a resistor R8 is connected to a 17th pin of the chip U1, and the resistor R8 is connected to the power supply circuit.

5. The detection device for detecting capacity of a granular furnace material box according to claim 4, wherein the DC-DC conversion circuit comprises a chip U2, a 1st pin of the chip U2 is connected to one end of a resistor R4, the other end of the resistor R4 is connected to the 4th pin of the chip U1, a 2nd pin of the chip U2 is respectively connected to+3.3V, a diode D1, one end of a capacitor C6, and one end of a capacitor C7; the other ends of the capacitor C6 and capacitor C7 are grounded;
a 4th pin of the chip U2 is connected to a capacitor C4, a capacitor C5, and a 2nd pin of a connector CN2; the 4th pin of the chip U2 is grounded, a 5th pin of the chip U2 is connected to one end of an inductor L1, and the other end of the inductor L1 is connected to the capacitor C4, the capacitor C5, and a 1st pin of the connector CN2.

6. The detection device for detecting capacity of a granular furnace material box according to claim 4, further comprising a burning circuit, wherein the burning circuit comprises a connector CN3, a 7th pin of the chip U1 is connected to a 3rd pin of the connector CN3, a 1st pin of the connector CN3 is connected to +3.3V, and a 2nd pin of the connector CN3 is grounded.
